(19) United States
(12) Patent Application Publication
(10) Pub. No.: US 2015/0236741 A1
(43) Pub. Date: Aug. 20, 2015

(54) Radio frequency front-end based on high-intermediate frequency superheterodyne and zero intermediate frequency structure

(71) Applicant: Yingjin YUAN, Tianjin (CN)

(72) Inventors: Jianguo Ma, Tianjin (CN); Wei Zhang, Tianjin (CN); Liang Zhang, Tianjin (CN); Yiqiang Zhao, Tianjin (CN)

(73) Assignee: Tianjin University, Tianjin (CN)

(21) Appl. No.: 14/117,628

(22) PCT Filed: Sep. 12, 2012
(86) PCT No.: PCT/CN12/81282

§ 371 Date: Nov. 14, 2013

(30) Foreign Application Priority Data
Aug. 22, 2012 (CN) 201210300528.1

(51) Int. Cl. H04B 1/26; H04B 1/40; H04L 27/00

(52) U.S. Cl. CPC H04B 1/26; H04L 27/0002; H04B 1/40; H04B 2001/0408

(57) ABSTRACT

The invention discloses a radio frequency front-end based on the high-intermediate frequency superheterodyne and zero intermediate frequency structure, which includes a transmitting module and a receiving module, wherein, the receiving module includes the following devices connected in turn with each other: a transceiving antenna, a low-pass filter, a superheterodyne unit, an IF band-pass filter, a zero-IF unit, a analog-to-digital converter and a digital baseband module of which the output is communicated with the transmitting module. The zero-IF unit includes the following devices which are also connected in turn with each other: a zero-IF mixer, an active low-pass filter and a variable gain operational amplifier of which the output is communicated with the input of the ADC; the inputs of the zero-IF mixer are communicated with the output of the IF band-pass filter and the second LO respectively. The present invention avoids the image interference, improves the system integration and decreases the system consumption.

### CROSS-REFERENCE TO RELATED APPLICATIONS

This application claims priority from PCT application Ser. No. PCT/CN2012/081282, filed Sep. 12, 2012 and CN Application No. CN201210300528.1, filed Aug. 22, 2012, the contents of which are incorporated herein in the entirety by reference.

### FIELD OF THE INVENTION

The present invention relates to a radio frequency front-end, and more particularly, to a radio frequency front-end based on high-intermediate frequency superheterodyne and zero intermediate frequency structure.

### BACKGROUND OF THE INVENTION

Among the numerous wireless access systems, the core element of the communication facilities is the RF front-end chip. The RF front-end is mainly used for amplifying, frequency converting, filtering and quantizing the weak signal received from the antenna of the receiver, and demodulating it to the baseband signal. Thus, design of the RF front-end circuit shows significant importance to the design of the whole receiver and has direct influence on the performance of the wireless receiving device.

A conventional RF front-end of a communication terminal is structurally constructed of: superheterodyne structure, zero intermediate frequency (IF) structure, double-conversion wide IF structure, double-conversion low IF structure, and the like. Wherein, the superheterodyne structure, due to its optimal sensibility, high selectivity and large dynamic range, is considered to be the most reliable topological structure of receiver and the preferred high-performance receiver. The typical superheterodyne structure, as shown in FIG. 1, employs mixer for converting the HF signal to a lower IF and then going through the channel filtering, amplifying and demodulating, to effectively overcome the problems when dealing with the HF signal. However, an IF filter with high-quality factor is necessity of filtering the image interference effectively, which is unrealizable in the existing CMOS process. Furthermore, as shown in FIG. 2, the IF of the superheterodyne structure is normally lower than the frequency of the RF signal, which leads to the existence of a fatal defect of image interference for the receiver. The superheterodyne structure is commonly applied to the RF front-end of the narrow-band communication system, when applied in the broad-band, such as receiving the 900 MHz RF signal in the 100 MHz to 1.2 GHz range with the superheterodyne structure, providing the IF frequency is of 13.56 MHz. In fact, the receiver receives not only the useful signal at 900 MHz, but also the image interference at 927.12 MHz. The image interference frequency of the RF front-end of the conventional superheterodyne structure totally falls in a narrow range around the useful channel, which has the defects of difficulty in distinguishing the two kinds of signals. The structure has a low sensitivity and is hard to integrate. Besides, when introducing the superheterodyne structure in the broad-band communication, the first local oscillator (LO) is strictly demanded. In the above-mentioned example, the tuning range of the frequency synthesizer is from 113.56 MHz to 1213.56 MHz, which has a lower center frequency and a tuning ratio of 85%.

### SUMMARY OF THE INVENTIONS

The object of the present invention is to provide an improved radio frequency front-end based on the high-intermediate frequency superheterodyne and zero intermediate frequency structure which effectively eliminates the image interference, improves the sensitivity and reliability of RF front-end circuit and also decreases the tuning ratio of LO.

The technical solution of the present invention is as follows: a radio frequency front-end based on the high-intermediate frequency superheterodyne and zero intermediate frequency (Zero-IF) structure includes a transmitting module and a receiving module. The receiving module includes the following parts which are connected with each other in turn: a transceiving antenna which is used for receiving the signal transmitted by the transmitting module, a low-pass filter, a superheterodyne unit, an IF band-pass filter, a Zero-IF unit, an analog-to -digital converter (ADC) and a digital baseband (DBB) module. The output of the digital baseband module is communicated with the transmitting module.

The transceiving antenna communicates with the low-pass filter by a wireless switch.

The superheterodyne unit includes a superheterodyne mixer, the inputs of which are communicated with a low noise amplifier (LNA) and a first local oscillator (LO) respectively; one output of the superheterodyne mixer is communicated with the input of the IF band-pass filter; wherein, the input of the LNA is communicated with the output of the low-pass filter.

The zero-IF unit includes the following devices which are connected with each other in turn: a zero-IF mixer, an active low-pass filter and a variable gain operational amplifier of which the output is communicated with the input of the ADC; the inputs of the zero-IF mixer are communicated with the output of the IF band-pass filter and the second LO respectively.

The transmitting module includes the following devices which are connected one another in turn: a modulation mixer, a power amplifier (PA) driving circuit and a power amplifier; the inputs of the modulation mixer are communicated with the output of the DBB module and the third LO respectively; and the output of the power amplifier is communicated with the wireless switch of the transceiving antenna.

The output of the superheterodyne unit (4) has a fixed-frequency of 2.45 GHz.

The tuning frequency of first LO ranges from 1.25 GHz to 2.35 GHz.

The radio frequency front-end of the present invention having the first IF of 2.45 GHz has the following advantages: A. Eliminating the image interference. When the frequency of the input RF signal ranges from 100 MHz to 1.2 GHz, the corresponding image interference frequency is from 3.7 GHz to 4.8 GHz which is out of the range of the input signal channel, thus avoiding the image interference. And the image suppressing filter and IF filter are not required accordingly, and further, improving the system integration and decreasing the system consumption; Meanwhile, comparing the LO tuning range between the conventional superheterodyne structure of which is 100 MHz to 1.2 GHz and the present invention of which is 1.25 GHz to 2.35 GHz, the center frequency increases from 650 MHz to 1.8 GHz, and the tuning ratio decreases from 85% to 30%, which dramatically reduces the design difficulty of the frequency synthesizer and makes it easy to implement the high-intermediate frequency superheterodyne structure. B. The technical solution of the present invention has high feasibility because the post processing technique for 2.45 GHz IF signal is rather matured.

### BRIEF DESCRIPTION OF THE DRAWINGS

FIG. 1 is a typical structure diagram of the superheterodyne structure based RF front-end;

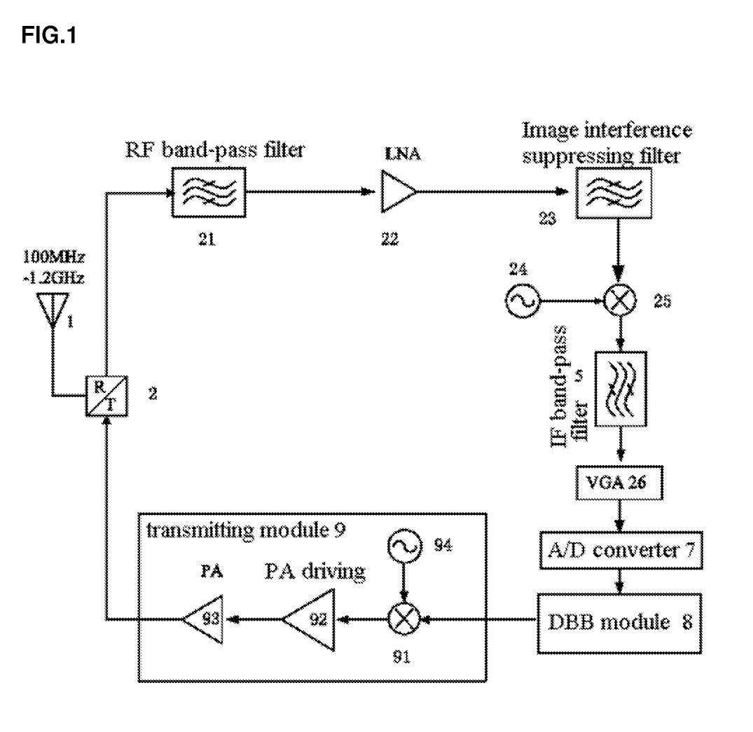

FIG. 2 is the schematic diagram showing the image interference;

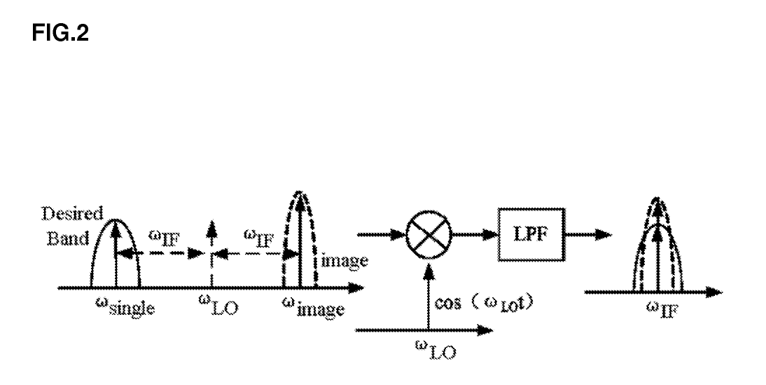

FIG. 3 is the structure diagram showing the RF front-end based on the high-intermediate frequency superheterodyne and zero IF structure of the present invention.

In the above drawings, the following reference numerals are provided:

1. transceiving antenna; 2. wireless switch; 3. low-pass filter; 4. superheterodyne unit; 5. IF band-pass filter; 6. Zero-IF unit; 7. analog-to-digital converter; 8. digital baseband (DBB) module; 9. transmitting module; 21. RF band-pass filter; 22. low noise amplifier; 23. image interference suppressing filter; 24. first LO; 25. superheterodyne mixer; 26. variable gain operational amplifier; 41. low noise amplifier; 42. superheterodyne mixer; 43. first LO; 61. zero-IF mixer; 62. second LO; 63. active low-pass filter; 64. variable gain operational amplifier; 81. modulation mixer; 82. power amplifier driving circuit; 83. power amplifier; 84. third LO.

### DETAILED DESCRIPTION OF PARTICULAR EMBODIMENTS OF THE INVENTION

Reference is now made to the accompanying drawings in which is shown an illustrative embodiment of the present invention from which its features and advantages will be apparent.

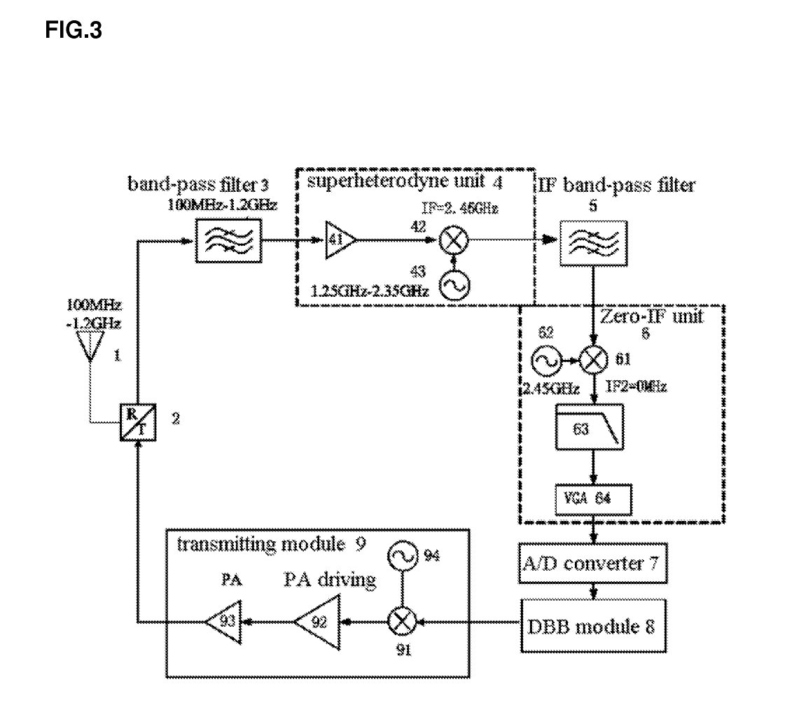

The RF front-end based on the high-intermediate frequency superheterodyne and zero intermediate frequency structure of the present invention includes a transmitting module and a receiving module, wherein, the receiving module is used for receiving, filtering, up-converting, down-converting and demodulating the RF signal; while the transmitting module is used for modulating and transmitting the base-band signal. As shown in FIG. 3, said receiving module includes the following devices which are connected to each other in turn: a transceiving antenna 1 communicates with a low-pass filter by a wireless switch 2, a low-pass filter 3, a superheterodyne unit 4, an IF band-pass filter 5, a Zero-IF unit 6, a analog-to-digital converter 7 and a DBB module 8 of which the output is communicated with the transmitting module 9.

The superheterodyne unit 4 includes a superheterodyne mixer 42, the inputs of which are communicated with a low noise amplifier (LNA) 41 and a first LO 43 respectively; the output of the superheterodyne mixer 42 is communicated with the input of the IF band-pass filter 5; and the input of the LNA 41 is communicated with the output of the low-pass filter 3. The output of the superheterodyne mixer 42 of the superheterodyne unit 4 has a fixed-frequency of 2.45 GHZ; and the tuning frequency of first LO 43 ranges from 1.25 GHz to 2.35 GHz.

The zero-IF unit 6 includes the following devices which are connected to each other in turn: a zero-IF mixer 61, an active low-pass filter 63 and a variable gain operational amplifier 64 of which the output is communicated with the input of the ADC 7; the inputs of the zero-IF 61 mixer are communicated with the output of the IF band-pass filter 5 and the second LO 62 respectively.

The transmitting module 9 includes the following devices which are connected to each other in turn: a modulation mixer 91, a power amplifier (PA) driving circuit 92 and a power amplifier 93; the inputs of the modulation mixer 91 are communicated with the output of the DBB module 8 and the third LO 94 respectively; and the output of the power amplifier 93 is communicated with the wireless switch 2 of the transceiving antenna 1.

The operating principle of the receiving module of the RF front-end of the present invention is as follows: the transceiving antenna receives the RF signal, the output of which communicates with the low-pass filter which is used for low-pass filtering the RF signal to eliminate the interference; the output of the low-pass filter communicates with the low noise amplifier for low noise amplifying the weak useful signal, which is convenient to the post circuit processing; the outputs of the low noise amplifier and the first LO communicate with the superheterodyne mixer for up-converting the signal to the first IF frequency at 2.45 GHz. The output of the superheterodyne mixer communicates with the IF band-pass filter for filtering the interference and selecting channel. The outputs of the IF band-pass filter and the second LO communicate with the zero-IF mixer for down-converting the first IF signal to low IF, so that it can be processed by the digital circuit. The output of the zero-IF mixer communicates with the active low-pass filter for filtering clutters; the output of the active low-pass filter communicates with the variable gain operational amplifier which output communicates with the A/D converter of the ADC and DBB module to convert the IF analog signal to digital signal which can be processed by the base band; further, the output of the A/D converter communicates with the digital base-band circuit for demodulating.

The operating principle of the transmitting module of the RF front-end of the present invention is as follows: the outputs of the digital base-band circuit of the ADC and DBB module and the third LO communicate with the modulation mixer for modulating the base band signal to the RF frequency; the output of the modulation mixer communicates with the power amplifier driving circuit that is used to drive the power amplifier to improve the transmitting power; further, the output of the power amplifier communicates with the transmitting antenna.

The first IF of the transmitting module of the RF front-end of the present invention has a fixed-frequency of 2.45 GHz. When the frequency of the input RF signal ranges from 100 MHz to 1.2 GHz, the corresponding image interference frequency is from 3.7 GHz to 4.8 GHz which is out of the range of the signal channel, thus the image interference can be easily filtered by adopting a low-pass filter with simple structure, and can avoid the image interference, improve the system integration and decrease the system consumption. Meanwhile, when compared to the LO tuning range between the conventional superheterodyne structure of which is 113.56 MHz to 1213.56 MHz and the present invention of which is 1.25 GHz to 2.35 GHz, the center frequency increases from 650 MHz to 1.8 GHz, the tuning ratio decreases from 85% to 30%, which dramatically reduces the design difficulty of the frequency synthesizer and is easy to implement the high-intermediate frequency superheterodyne structure. Furthermore, the technical solution of the present invention has high feasibility because the post processing technique for 2.45 GHz IF signal is rather matured.

The principles and features of this invention may be employed in various and numerous embodiments without departing from the scope of the invention.

What is claimed is:

1. A radio frequency (RF) front-end based on the high-intermediate frequency superheterodyne and zero intermediate frequency (zero-IF) structure comprising a transmitting module and a receiving module, wherein, the receiving module comprises: a transceiving antenna (1), a low-pass filter(3), a superheterodyne unit (4), an IF band-pass filter (5), a zero-IF unit (6), a analog-to-digital converter (ADC) (7) and a digital baseband (DBB) module (8) of which an output is communicated with the transmitting module (9).

2. The radio frequency front-end according to the claim 1, wherein the transceiving antenna (1) communicates with the low-pass filter(3) by wireless switch (2).

3. The radio frequency front-end according to the claim 1, wherein the superheterodyne unit (4) comprises a superheterodyne mixer (42), the inputs of which are communicated with a low noise amplifier (LNA) (41) and the first local oscillator (LO) (43) respectively; and the output of the superheterodyne mixer (42) is communicated with the input of the IF band-pass filter (5); wherein, the input of the LNA (41) is communicated with the output of the low-pass filter(3).

4. The radio frequency front-end according to the claim 1, wherein the zero-IF unit (6) comprises the following devices which are connected with each other in turn: a zero-IF mixer (61), an active low-pass filter(63) and a variable gain operational amplifier (64) of which an output is communicated with the input of the ADC(7); the inputs of the zero-IF mixer (61) are communicated with the output of the IF band-pass filter (5) and the second LO (62).

5. The radio frequency front-end according to the claim 1, wherein the transmitting module (9) comprises the follows which are connected with each other in turn: a modulation mixer(91), a power amplifier (PA) driving circuit (92) and a power amplifier (93); the inputs of the modulation mixer (91) are communicated with the output of the DBB module (8) and the third LO (94); and the output of the power amplifier (93) is communicated with the wireless switch (2) of the transceiving antenna (1).

6. The radio frequency front-end according to the claim 1, wherein the output of the superheterodyne unit (4) has a fixed-frequency of 2.45 GHz.

7. The radio frequency front-end according to the claim 3, wherein the tuning range of the first LO (43) ranges from 1.25 GHz to 2.35 GHz.
